(19) United States
(12) Patent Application Publication
(10) Pub. No.: US 2006/0136131 A1
(43) Pub. Date: Jun. 22, 2006

(54) VEHICLE DETECTOR AND VEHICLE PARKING MANAGEMENT SYSTEM

(75) Inventors: William P. Dugan, Lake Forest, IL (US); Mark R. Dee, New Brunswick (CA); Feisal A. Hurzook, Ontario (CA)

Correspondence Address: VEDDER PRICE KAUFMAN & KAMMHOLZ, 222 N. LASALLE STREET, CHICAGO, IL, 60601, US

(73) Assignee: METERTEK, LLC, Bannockburn, IL (US)

(21) Appl. No.: 11/164,810

(22) Filed: Dec. 6, 2005

Related U.S. Application Data
(60) Provisional application No. 60/633,619, filed on Dec. 6, 2004.

(51) Int. Cl. G07B 15/00; G05D 1/02

(52) U.S. Cl. 701/300; 705/13

(57) ABSTRACT

A detector assembly including a three-dimensional magnetic sensor adapted to detect presence of a vehicle, a transceiver operatively coupled to the magnetic sensor and adapted to send and receiver information, a microprocessor operatively coupled to the magnetic sensor and the transceiver. The detector assembly is part of a vehicle parking management system including a plurality of detector assemblies and a remote device operatively coupled to the plurality of sensor assemblies to exchange information with each of the plurality of sensor assemblies.

### RELATED APPLICATION

The present application claims the benefit of provisional patent application Ser. No. 60/633,619, filed Dec. 6, 2004.

### BACKGROUND

The present disclosure generally relates to object detection and use of such information in the operation of a system, and more particularly, to a detector for use in a vehicle parking management system to indicate the presence of vehicles.

Conventional vehicle detection systems use detectors that incorporate two-dimensional magnetic sensors. Often other sensors, such as a zero-slope detector, are used to provide additional information with respect to detection of vehicles. However, such detectors have disadvantages. One disadvantage of a two-dimensional sensor is that changes in the two dimensions can be cancelled out by adjacent bodies on the same dimensional plane. The additional information provided by the third dimension vastly improves vehicle detection. An additional disadvantage is that the zero-slope detector does not work with a stationary car. Rather, such a sensor is used for monitoring vehicles as they pass over the sensor, not for monitoring stationary nearby vehicles. Furthermore, the conventional vehicle detectors do not periodically adjust for changes or drift in the ambient baseline magnetic field. The earth's magnetic field constantly changes or drifts as a result of many factors. As a result, conventional two-dimensional sensors are more often subject to false readings which will result in errors in any vehicle detection system. Another disadvantage is that the magnetic sensors are subject to drift as a result of a change in temperature. As a result, a sensor that has detected a vehicle in the morning, may not detect when it has left. Resulting in a loss of revenue to the operator of the facility.

Therefore, there exists a need in the art for a detector assembly and a vehicle parking system which uses a precision three-axis magnetic sensor that accounts for drift in magnetic field and as a result of temperature changes and overcomes all the disadvantages of the prior art.

### BRIEF DESCRIPTION OF THE DRAWINGS

Certain embodiments are shown in the drawings. However, it is understood that the present disclosure is not limited to the arrangements and instrumentality shown in the attached drawings, wherein:

FIG. 1 is a block diagram of a detector assembly constructed in accordance with the teachings of one embodiment of the present disclosure.

FIG. 2 is a block diagram of one vehicle parking management system constructed in accordance with the teachings of one embodiment of the present disclosure.

FIG. 3 is a state diagram for a detector assembly constructed in accordance with the teachings of one embodiment of the present disclosure.

FIG. 4 is a state diagram of one vehicle parking management system constructed in accordance with the teachings of another embodiment of the present disclosure.

FIG. 5 is a schematic diagram representing another vehicle parking management system constructed in accordance with the teachings of another embodiment of the present disclosure.

FIG. 6 is a schematic diagram representing another vehicle parking management system constructed in accordance with the teachings of another embodiment of the present disclosure.

FIG. 7 is a schematic diagram representing another vehicle parking management system constructed in accordance with the teachings of another embodiment of the present disclosure.

FIG. 8 is a schematic diagram representing another vehicle parking management system constructed in accordance with the teachings of another embodiment of the present disclosure.

FIG. 9 is a schematic diagram representing another vehicle parking management system constructed in accordance with the teachings of another embodiment of the present disclosure.

### SUMMARY

In accordance with one principal aspect of the present disclosure, a detector assembly comprises a passive sensor adapted to detect presence of an object, generally a vehicle, a transceiver operatively coupled to the sensor and adapted for bidirectional communication with a remote device, and a microprocessor operatively coupled to the sensor, the transceiver, and a memory. The memory stores programming instructions that, when used by the microprocessor, cause the detector assembly to function. The functions of the detector assembly include, inter alia, activating the sensor to determine a baseline ambient three-dimensional field around the sensor in an initial state and periodically thereafter to determine a then-current ambient three-dimensional magnetic field. An adjusted baseline is determined from a difference between the baseline and then-current magnetic fields. In the event the difference exceeds a threshold, the presence of a vehicle has been determined in the predefined location.

In accordance with another principal aspect of the present disclosure, a vehicle parking management system comprises a plurality of detector assemblies, each configured and functional as described above, a server operatively coupled to the plurality of detector assemblies and a payment source operatively coupled to the server.

In accordance with another principal aspect of the present disclosure, vehicle parking management system comprises a plurality of detector assemblies, each configured and functional as described above and a payment collection device operatively coupled with each of the plurality of detector assemblies.

In accordance with another principal aspect of the present disclosure, vehicle parking management system comprises a plurality of detector assemblies, each configured and functional as described above and a payment collection device operatively coupled with the plurality of detector assemblies.

In accordance with another principal aspect of the present disclosure, vehicle parking management system comprises a plurality of detector assemblies, each configured and functional as described above, a dynamic display operatively coupled to the plurality of detector assemblies and a payment source operatively coupled to the dynamic display.

In accordance with another principal aspect of the present disclosure, vehicle parking management system comprises a plurality of detector assemblies, each configured and functional as described above, a mobile communication device operatively coupled to at least one of the plurality of detector assemblies and a payment source operatively coupled to the mobile communication device and the at least one of the plurality of detector assemblies.

### DETAILED DESCRIPTION

For the purposes of promoting and understanding the principles disclosed herein, reference will now be made to the preferred embodiments illustrated in the drawings and specific language will be used to describe the same. It will nevertheless be understood that no limitation of the scope is thereby intended. Such alterations and further modifications in the illustrated device and such further applications are the principles disclosed as illustrated therein as being contemplated as would normally occur to one skilled in the art to which this disclosure relates.

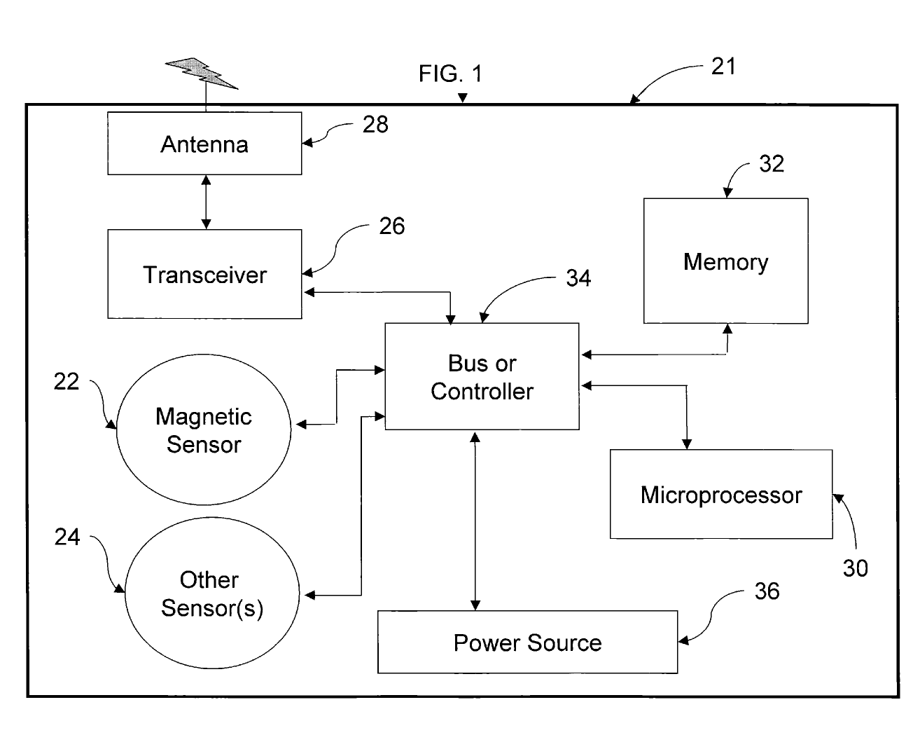

Referring to FIG. 1, a detector assembly 20 constructed in accordance with the teachings of one embodiment of the present disclosure is diagrammatically shown. In one embodiment, the detector assembly 20 includes at least a passive sensor 22, a transceiver 26 and a microprocessor 30, and a power source 36, all of which are housed in an enclosure 21.

Preferably, the passive sensor 22 is a three-axis magnetic sensor. However, it is within the teachings of the present disclosure that the passive sensor may also be configured to function to achieve the advantages described herein under one or a combination of the following formats: ultra-sonic, infra-red, radar, laser, capacitive or photoelectric. Please note that for consistency with respect to the preferred embodiment, hereinafter the terms “sensor,” “passive sensor” and “magnetic sensor” will be used interchangeably and each represents the full range of possible alternatives, set forth herein or hereafter developed which perform like functions. In another preferred embodiment, the magnetic sensor 22 may detect magnetic field strength and direction relative to pre-existing ambient magnetic field conditions. Preferably, the magnetic sensor 22 is adapted to detect information regarding the presence of a stationary object, eg. vehicle, near the magnetic sensor 22 and to operate in response to programming instructions in order to facilitate the detector to constantly, in real-time, compensate for the drift of the earth's magnetic field adjacent the predefined location. In one embodiment, the sensor 22 monitors the three-dimensional magnetic field generated by the earth and surroundings adjacent to and around the sensor 22 and distortions or perturbations in such three-dimensional magnetic field. It will be recognized by those of skill in the art that the earth's magnetic field may also vary and drift differently from predefined location to another predefined location.

In one embodiment, the sensor 22 may be, for example Honeywell HMC1022 and/or HMC1021Z. Other similarly constructed and functionally equivalent sensors may be used by substitution.

The transceiver 26 is operatively coupled to the magnetic sensor 22 in a conventional manner and is adapted for bidirectional communication with a remote device (as described in detail below) to send the information obtained from the magnetic sensor 22 outside the detector assembly 20 and to receive information from the remote device with respect to functionality of the sensor and operational instruction sets and parameters of the detector assembly, which may be selectively adjusted dynamically in real-time. In one embodiment, the transceiver 26 may be any suitable compatible conventional device that performs the intended function as identified herein. Other similarly constructed and functionally equivalent sensors may be used by substitution.

The terms “operatively couple,” “operatively coupled” and “bidirectional communication,” or any variations thereof, as used herein shall not be read in an limiting sense, shall be used interchangeably and shall be used to describe any suitable wired or wireless format or protocol. Including without limitation, wired voltage or current driven communications over twisted and non-twisted pairs, radio frequency, electrical-optical converters, such a light emitting diodes, lasers, photodiodes and acoustic devices, such as piezoelectric and ultrasonic transducers.

The microprocessor 30 is operatively coupled to the magnetic sensor 22 and the transceiver 26, both in any suitable conventional manner, and controls the operations of the transceiver 26 and the magnetic sensor 22 by executing programming instructions stored in the memory 32. In one embodiment of the present disclosure, the microprocessor 30 may be any suitable compatible conventional device that performs the intended function as identified herein and the memory may be any suitable compatible conventional device that performs the intended function as identified herein. One of skill in the art will recognize that the microprocessor may be configured as hardware or software or a combination thereof, without limitation, microcontrollers, embedded microcontrollers, programmable digital signal processors or other programmable device, along with internal and/or external memory such as read-only memory, programmable read-only memory, electronically erasable programmable read-only memory, random access memory, dynamic random access memory, double data rate random access memory, Rambus direct random access memory, flash memory, or any other volatile or non-volatile memory for storing program instructions, program data, and program output or other intermediate or final results, and also or instead, include an application specific integrated circuit, a programmable gate array, programmable array logic, or any other device that may be configured to process electronic signals.

The power source 36 provides the power necessary for the operations of the microprocessor 30, the transceiver 26, and the magnetic sensor 22. In one embodiment, the power source 36 may be a power supply or a battery. Preferably, in one embodiment, the power source 36 may be any suitable compatible conventional device that performs the intended function as identified herein. However, it is within the teachings of the present disclosure that any other suitable power source may be used. In fact, the power source may be provided by wired or wireless connection to an external power source.

In operation, the sensor 22 is normally in a deactivated state. The sensor 22 is preferably only activated to passively determine the baseline and then-current ambient three-dimensional magnetic fields around the sensor 22 as instructed by the microprocessor. Similarly, the detector assembly 20 may be placed into a “sleep” mode during those times when it is know or highly likely that activity around the sensor is minimal or non-existent. Both of such operational modes described in this paragraph facilitate minimizing use of the power available from the power source. It will be recognized by those of skill in the art that such methods are particularly valuable in those installations where access to the detector assembly 20 is difficult or problematic.

The detector assembly 20 may include additional components for its operation, including other sensors 24 and an antenna 28. The other sensors 24 may be sensors that are known to those of ordinary skill in the art, such as temperature, vibration sensors, RFID (radio frequency identification) sensors, or other sensors that can detect motion, heat, light, or the like. Preferably, the a temperature sensor is provided which as a result of conventional function generates an output to the microprocessor 30 so that the microprocessor 30 can use the output in connection with the programming instructions in the memory 32 to function to adjust a selection from the group consisting of the baseline, then-current and adjusted baseline ambient three-dimensional magnetic field around the sensor 22 and the threshold (all as will be described in more detail below).

In one embodiment, the other sensor 24 may include an active sensor which is operatively coupled to the microprocessor 30 and activated thereby in response to programming instructions in the memory 32 when the vehicle is detected and functions to actively confirm presence of the vehicle. Such an active sensor may be configured to function to achieve the advantages described herein under one or a combination of the following formats: ultra-sonic, infra-red, radar, laser, capacitive or photoelectric.

The memory 32 may store programming instructions and information that is necessary for the operation of the detector assembly 20 and can function as a buffer for the microprocessor 30. The memory 32 may also collect information from the magnetic sensor 22 and send the information to the microprocessor 30 for processing before such information is transmitted with the transceiver 26. It is within the teachings of the present disclosure that the programming instructions may be realized as computer executable code created using a structured programming language such as C, an object-oriented programming language such as C++ or java, or any other high-level or low-level programming language that may be compiled or interpreted to run on one of the above devices, as well as heterogeneous combinations of processors, processor architectures, or combinations of different hardware and software and may be deployed using software technologies or development environments including a mix of software languages, such as Microsoft IIS, Active Server Pages, Java, C++, Oracle databases, SQL, and so forth.

The antenna 28 may be integral to the transceiver 26 or may be a separate component of the detector assembly 20. The detector assembly 20 may also include a bus or controller 34 that can facilitate the exchange of information between all of the above-noted components in any conventional or suitable manner. The bus or controller 34 can also distribute power from the power supply 36 to all of the above noted components in any conventional or suitable manner.

The enclosure 21 may be constructed from any type of non-magnetic metal, plastic, rubber, synthetic, natural or composite materials (e.g., fiberglass, glass reinforced plastic, etc.), or the like. The material and the shape of the enclosure 21 may be selected depending on the particular application in which the detector assembly 20 is used. If the detector assembly 20 is to be installed underground at a roadway or a parking stall, the enclosure 21 may be preferably constructed with any type of corrosion resistant material that can withstand the forces to which the enclosure 21 may be exposed. The enclosure 21 may also include a variety of gaskets and seals where individual parts thereof join together to provide weather sealing of the enclosure 21. The enclosure 21 may be shaped like a disk, a short and wide cylinder (e.g., similar to a hockey puck, tuna can, etc.), a sphere, a box, or a number of other possible configurations, any of which may be suitable for a particular application.

The remote device (as discussed in more detail below with respect to various embodiments in this present disclosure) may be selected from the group consisting of a server, a payment source, and enforcement authority, a payment collection device, a mobile communication device, a vehicle interface unit and a dynamic display. Each detector assembly 20 may be configured to be operatively coupled with any such remote device depending on the desired configuration of the vehicle parking management system.

The server may be a computer or other suitable device for managing operations of the vehicle parking management system. For example, the server may be a computer or other computing device that performs similar functions, a server platform, an application server, a chat server, an file transfer protocol server, a groupware server, an internet relay chat server, list server, mail server, news server, proxy server, telnet server or web server or any other suitable device. In some embodiments of the present disclosure, the detector assemblies, payment collection device, mobile communication device, vehicle interface unit, dynamic display and other elements may be configured to perform the function and operations of the server if so desired.

The payment source may be any source from which a user access or make available funds for paying for the predefined location for a predetermined period of time. For example, a user may insert coins or cash in a payment collection device as a payment source. Similarly, such payment collection devices may accept credit or debit cards as a payment source. Alternatively, the payment source may be an electronically accessible account at a bank, financial institution or other similar entity. Additionally, similar available internet sources, such as PayPal.com or other websites that provide for transfer of funds, may be used as the payment source. Furthermore, a mobile communication device such as a user mobile phone, personal digital assistant, electronic mail device, hand-held microcomputer, laptop or pager may be a payment source. In such a configurations, the mobile communication device not only facilitates the transfer of funds, but the funds may be charged or debited to the mobile communication device. For example only and not by way of limitation, a user cell phone may be configured to facilitate transfer of funds by manipulation of the keypad from a bank account to the account of the account of the operator of the vehicle parking management system or to the cell phone account as a debit representing an amount transferred to the account of the operator of the vehicle parking management system. It is within the teachings of the present disclosure that the payment source be construed very broadly as any source accessible by the user to transfer funds to the account of the operator of the vehicle parking management system.

The enforcement authority may be a municipality or other governmental entity or any private entity with an interest in or responsibility for the operation of a vehicle parking management system. Alternatively, an agent of either of the above may also be considered an enforcement authority as would anyone or entity acting at their direction. The enforcement authority may be the operator of the vehicle parking management system, but is not required to be so. For example, a governmental entity may engage a private entity to operate the vehicle parking management system with respect to setting operational parameters, operational states, pricing, collection of fees and citation of violations. Alternatively, the governmental entity may retain some or all operational functions, in which case it would be an enforcement authority as well. Any other suitable arrangement may be configured to function in the present disclosure.

The payment collection device may be a conventional parking meter, in any of its numerous configurations, or what is referred to in the parking industry as a pay and display machine, in any of its numerous configurations. Generally, a single meter is associated with a single predefined parking location. However, a pay and display machine is generally associated with a plurality of parking locations. It is within the teachings of the present disclosure that any other suitable device which accepts funds from a payment source may be referred to as a payment collection device.

The mobile communication device may be a vehicle interface unit (as described in more detail below), a user communication device or an enforcement authority communication device. The user communication device commonly may be a mobile phone. However, it may be a personal digital assistant, electronic mail device, hand-held microcomputer, laptop or pager or any other suitable device to provide similar functionality, namely communication with the user. The enforcement authority communication device commonly may be a hand-held device used by the enforcement authority or officers or agents thereof. Similarly, the enforcement authority communication device may be a mobile phone, a personal digital assistant, electronic mail device, hand-held microcomputer, laptop or pager or any other suitable device to provide similar functionality, namely communication with the enforcement authority.

The vehicle interface unit may be any device that permits one in a vehicle to interact or communicate with the vehicle parking management system. For example, the vehicle interface unit may be a properly configured navigation unit integrated into a vehicle, a laptop operatively coupled with the vehicle and a remote device or any other suitable device to perform the intended functions.

The dynamic display may be a multi-line display which communicates information regarding the vehicle parking management system to a user. For example, the dynamic display may illustrate the number of available parking spaces in an associated lot(s), the fees for parking, operational parameters of the associated lot(s) and any other information regarding the vehicle parking management system that may be useful to the user. The dynamic display may also be updated, changed, upgraded, etc. in real-time to alter operational parameters or other functional aspects thereof.

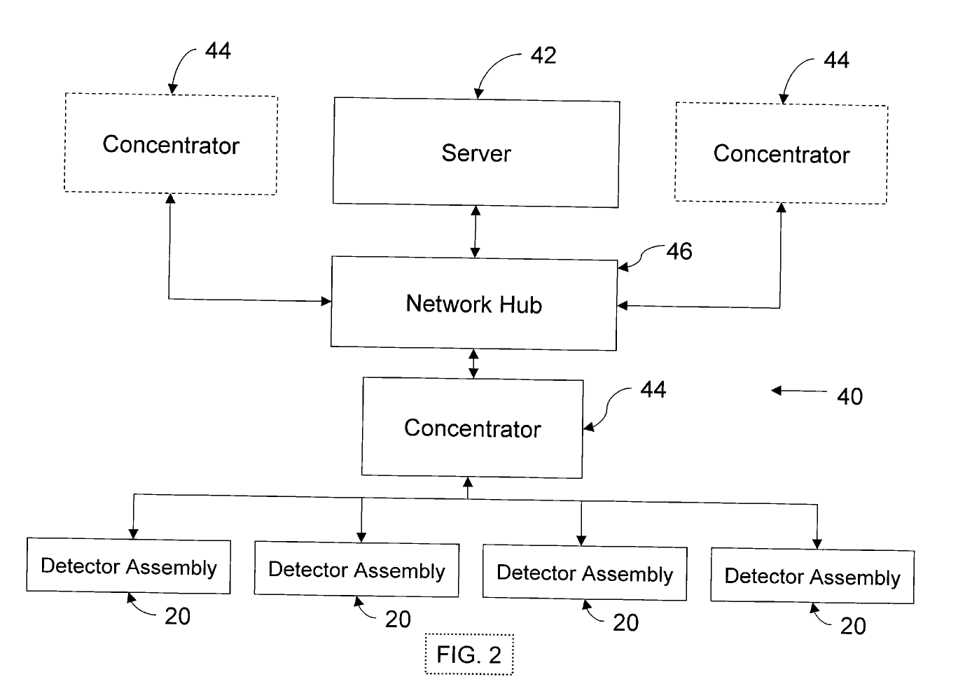

Referring to FIG. 2, one embodiment of a basic vehicle parking management system 40 constructed in accordance with the teachings of one embodiment of the present disclosure is diagrammatically shown. The vehicle parking management system 40 includes a plurality of sensor assemblies 20, each of which is configured and enabled to function as described above and in more detail below, configured to detect the presence or absence of a vehicle parked stationary proximate thereto. Each detector assembly 20 may be installed or located near where a vehicle may be present or absent at certain times or intermittently. For example, each detector assembly 20 may be located at, near or around a parking stall or a predefined location. Accordingly, the presence of a vehicle in the parking stall or the absence of the vehicle from the parking stall can be detected by the detector assembly 20. For example, each detector assembly 20 of the plurality of sensor assemblies 20 can be installed at each predefined location along a street, inside a garage, in a parking lot or at other locations where vehicles may be parked or any other suitable of desirable location and/or orientation.

As will be described in detail in the following and without limitation, each detector assembly 20 can be installed inside or near a parking meter 27 (shown in FIG. 1), at each parking stall in the ground, in a hollowed rubberized section of the parking curb, or in the base of a parking sign at each parking stall. At each of the noted locations, the detector assembly 20 can detect the presence of the vehicle in the predefined location with which it is associated. Additionally, by placing the detector assembly 20 in the base of a parking stall, a visual display, which may be a dynamic display, may be used to communicate with the detector assembly to alert the driver of the vehicle about the status or location of the parking stall (e.g., whether there is a parking stall available in the associated parking facility and where it may be within such facility or about the particular parking rules or operational parameters that apply to such parking facility or stall).

Each detector assembly 20 uses periodic three-dimensional magnetic field monitoring to detect differences in the three-dimensional magnetic field around the sensor against a detection threshold to determined the presence of a vehicle within its proximity. The magnetic sensor 22 can be a magneto-resistive bridge that checks for variations, changes or perturbations in the three-dimensional magnetic field. Initially, baseline ambient three-dimensional magnetic field readings are taken when no vehicle is present. As a vehicle with sufficient magnetic mass comes within proximity of the detector assembly 20, a variation, change or perturbation in the earth's three-dimensional magnetic field, in comparison with the ambient readings, can signify the presence of the vehicle. The noted comparison in the magnetic field readings and the ambient readings can be carried out by the microprocessor 30. The memory 32 may include algorithms that process information from the magnetic sensor 22 with the microprocessor 30 to determine the presence of a vehicle. Additionally, real time detection information detected by the magnetic sensor 22 can be stored in the memory 32 and executed in the microprocessor 30 to place information in a more usable form so that it can be transmitted with the transceiver 26. Transmissions from the detector assembly 20 may wireless in one embodiment and may be made by using a radio in such embodiment. The radio frequency can be configured to any combination of licensed or unlicensed bands. Other modes of transmission of the information may be used as described above, such as a wired connection.

To reduce the power requirements in one embodiment of the detector assembly 20, short distance communication is used from the detector assembly 20 to a concentrator 44. The concentrator 44, which may be above ground, gathers the information from the sensor assemblies 20 and forwards the information to a server 42 using a WAN (wide area network). Accordingly, the high power consumption of the wireless communication is between the concentrator 44 and the server 42 and not between the sensor assemblies 20 and the concentrator 44. As shown in FIG. 2, the vehicle detection system 40 may have several concentrators 44, each of which has a variety of sensor assemblies 20 connected thereto. Additionally, the concentrators 44 may be all connected to a network of 28 that communicates with the server 42. Moreover, the concentrators 44 may be incorporated into a dynamic display or other suitable structure already associated with the vehicle parking management system.

As one of ordinary skill in the art will readily appreciate power management may be a factor to consider in how the detector assembly 20 performs and defines the time when the power source 36 needs to be recharged or changed. The power management of the detector assembly 20 is particularly important if the detector assembly 20 is buried underground or near the surface of the ground. For example, sending information to the server 42 only when the status of the detector assembly 20 changes and requires such communication can reduce the power expended for the radio transmission from the transceiver 26 back to the server 42.

To further conserve power, when the detector assembly 20 is inactive, the detector assembly 20 can be placed in a sleep mode for a period of time to further reduce power consumption. The concentrator 44 also provides power saving features by being able to send information to the server 42 using a connectionless protocol. Also, the concentrator 44 may only accept information at predetermined times from each of the sensor assemblies 20. Accordingly, the concentrator 44 cues the information being transmitted from the server 42 to the sensor assemblies 20 until such time that the sensor assemblies 20 are ready to accept the information. The concentrator 44 then notifies the server of the successful delivery of information to each detector assembly 20.

To further increase power savings, the microprocessor 30 can turn on at predetermined intervals as defined by the server 42 and test for a vehicle's presence. If the status of the vehicle has changed, the microprocessor 30 can then power up the transceiver 26 and broadcast a message to the concentrator 44. The magnetic sensor 22 even provides power saving features as compared to other sensors that may provide vehicle detection. The detection of the magnetic sensor 22 is performed by the passive measurement of the earth's magnetic field. Accordingly, unlike resonant loop, ultrasonic, inductive, and capacitive sensors, the magnetic field detection of the magnetic sensor 22 provides low power consumption.

The detector assembly 20 can determine how long a vehicle has been parked in the parking stall or predefined location to which the detector assembly 20 is assigned. The detector assembly 20 may be programmed by the server 42 with a predetermined time for that particular parking stall. When that vehicle has been parked in that parking stall for more than the predetermined time, a detector assembly 20 indicates to the server 42 that the time for the vehicle has expired relative to the predetermined time. The server 42 can then take appropriate action. The server's action may simply be a statistical observation regarding the individual parking habits, dispatching an agent of the enforcement authority to the offending location, communicating with the user to advise of the expired time or request if additional time would like to be purchased or any other suitable desired action. In the event the user advises the server 42 that additional time is to be put on the “meter” (as colloquially referred to), really the detector assembly in this embodiment, the server can “push time on to the meter” or in other words, update the detector assembly so that the predetermined time has been extended and what the new expiry time is. The statistical observations may be used for parking facilities that offer free parking without any time limitations. If the time limitation for parking a vehicle is to be strictly enforced, then an agent of the enforcement authority can be dispatched by the server 42 to the offending location to ticket the vehicle.

The rules and algorithms of operation, operational parameters or programming instructions of each detector assembly 20 (including but not limited to the threshold and sensing algorithm) may be stored in the memory 32 as programming instructions for execution by the microprocessor 30. However, these rules and/or algorithms are not fixed or static. Rather, the server 42 can selectively change the operational parameters or programming instructions stored in each detector assembly 20 so as to make them dynamic and flexible. For example, during special events or special times of a day, the rules in the detector assembly 20 can be changed. During lunch time, the operator of the vehicle parking management system may decide to provide a shorter time per unit of fees for vehicles to park at the facility. During other times, however, the parking facility may wish to lengthen the time allowed. Therefore, the operator of the vehicle parking management system may decide to change the time limitation (e.g. lengthen) per unit of fees or a general operation of the detector assembly 20 depending on the requirements of the situation.

If there is time limitation on how long a vehicle can be parked for a certain unit of fees, the detector assembly 20 can start a timer that may be programmed in the memory 32 and processed by the microprocessor 30. Alternately, the detector assembly 20 can include an internal digital or analog timer (not shown) that is independent from the memory 32 or the microprocessor 30. After the predetermined time for which the vehicle is allowed to remain in the stall has expired, the detector assembly 20 transmits a signal to the server 42 with the transceiver 26 indicating that the time has expired. The server 42 may then communication with the user in any suitable manner and advise of same and inquire if additional time is to be purchased or dispatch an officer to ticket the vehicle if no additional time is to be purchased. In the event the vehicle leaves the predefined location prior to expiration of allotted time, the server 42 or detector assembly 20 may contact the user and advise him of same, which may serve to function as a theft deterrent or notification in the event of same.

As stated in the foregoing, the amount of time per unit of fees defined in each detector assembly 20 by the server 42 can change depending on the time of day, date, the year or a special event that may be occurring on a certain day. The detector assembly 20, as described above, may also include other sensors 24. One of such other sensors may be a radio frequency identification (“RFID”) sensor (not shown). RFID sensors provide the capability to each detector assembly 20 to determine a previously assigned specific vehicle's identification. Accordingly, the server 42 can determine the parking rights of that specific vehicle and not apply general parking rights that are applied to other vehicles in the parking facility. For example, a specific vehicle may be granted a monthly parking pass in the form of an RFID tag. Accordingly, the server 42 will receive the information of the vehicle from the RFID sensor of the detector assembly 20 and in turn alter the operational parameters of the detector assembly, if necessary.

Because each detector assembly 20 may be installed at a single parking stall or predefined location, the sensor assemblies 20 can include an identification tag that when communicated to the server 42 will indicate thereto the location of each of the sensor assemblies 20. Accordingly, the server 42 has information on the location of each of the sensor assemblies 20 relative to the parking facility. Therefore, because the server 42 can identify the specific areas of violation, it can route and manage the enforcement authority agents' activities throughout the parking facility.

Each detector assembly 20 and/or the vehicle parking management system 40 can be connected to outside payment sources or payment collection devices, as described above. For example, in one embodiment, each detector assembly 20 can be installed below, adjacent to or in the proximity of a parking meter and is operatively coupled thereto to read the funds collected or payment information from each parking meter. Accordingly, the detector assembly 20 can determine from the parking meter whether the time on the parking meter has expired. The detector assembly 20 can then inform the server 42 to dispatch an enforcement authority agent if the time on the parking meter 27 has expired, or contact the user and inquire if additional time is to be procured. In the event the vehicle leaves the predefined location after the enforcement authority agent is dispatched but prior to a citation being issued, the server can cancel the violation and recall or redirect the enforcement authority agent. Additionally, when a vehicle leaves a parking stall that has a parking meter, the detector assembly 20 can inform the server 42 that the vehicle has departed. Accordingly, the sensor can instruct the detector assembly 20 to zero the remaining time on the parking meter, if any.

Each detector assembly 20 and/or the server 42 can be connected to various electronic payment sources for those who may violate the parking rules, operational parameters or vehicle owners who have authorized the server to charge a specified credit account. The user can also instruct the vehicle parking management system to automatically deduct the parking fee from their credit account once their vehicle is disposed in the parking stall. Therefore, the server 42 and the sensor assemblies 20 can also provide money collection operations from each vehicle, if such operations are desired.

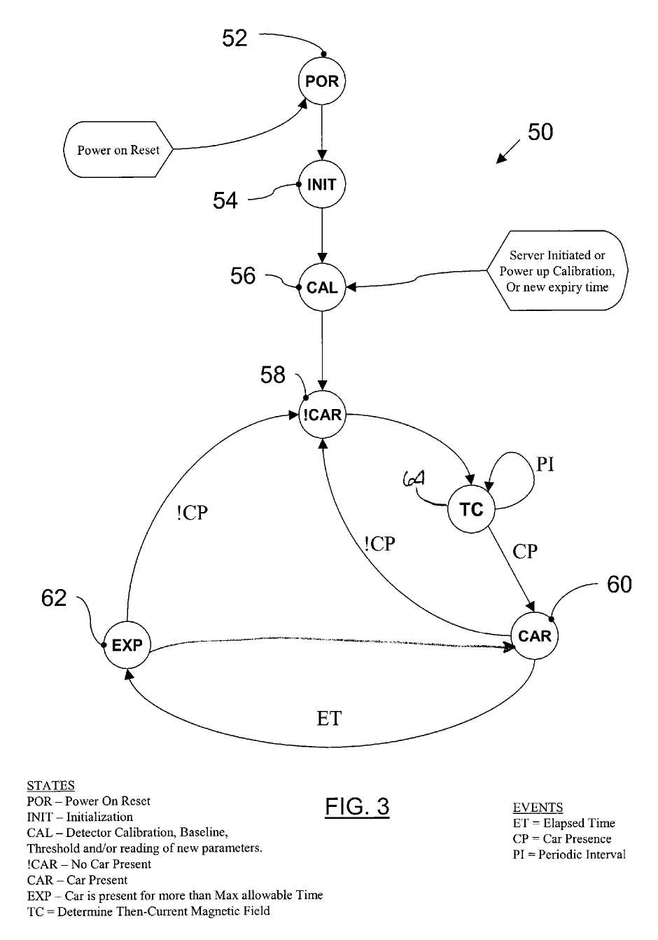

Referring to FIG. 3, a state diagram 50 of one embodiment of the disclosed vehicle parking management system 40 is shown. The state diagram of FIG. 3 represents one detector assembly of a vehicle parking management system used in a parking facility where each parking stall is not connected to a payment system. In other words, the driver of the vehicle does not have to make a payment at the parking stall once he parks the vehicle in the stall. As described in the foregoing, such parking facilities may be simply street parking or public garages where parking may be free but with time limitations on how long a vehicle may be parked in a parking stall.

In FIG. 3, each of the blocks 52-62 represents one of the operational states of a detector assembly 20 of a vehicle parking management system 40. Block 52 represents a power-on state that may represent when either a detector assembly 20 is powered up from a sleep mode or a detector assembly 20 is powered off and on to perform a reset operation. The reset operation may clear a portion of the memory of the detector assembly 20 so as there is no accumulative information from a previous day or a previous operation still remaining in the memory 32.

Block 54 represents an initialization state that may occur after a power on operation so as to download the necessary information for the operation of the detector assembly 20 from the server 42 into the memory 32, so as to upgrade, update or supplement the memory 32 or monitor maintenance parameters of the detector assembly 20.

State 56 is a calibration state that may represent a diagnostic state of the detector assembly 20. The calibration of the detector assembly 20 may include testing all of the components of the detector assembly 20, providing the detector assembly 20 with particular algorithms and testing those algorithms, and/or checking the level of the power source 36 to decide whether the detector assembly 20 requires a new power source 36.

In the calibration state, the programming instructions stored in the memory are used by the microprocessor to cause the detector assembly to function to: establish a set or operation states; establish a baseline status for each of the operational states; determine whether the status of one of the operation states has been altered as a result of detection of the vehicle; and determine whether the altered status requires notification of the remote device; as will be described herein. Additionally, a threshold detection level is also set. This threshold may be downloaded from the server or other device operatively coupled with the detector assembly or may be permanently stored in the memory.

A baseline ambient three-dimensional magnetic field around the sensor is also established. In order to accomplish this task, the memory uses certain programming instructions to cause the detector to activate the sensor, which the captures the ambient three-dimensional magnetic field around the sensor. This initial reading may serve as the baseline or a plurality of readings may be taken on a periodic basis to establish the baseline depending on configuration of the vehicle parking management system.

State 58 is a “car presence” state that represents a condition where a vehicle is not present in the magnetic sensor's proximity for detection, but the detector assembly is operational. On initial start-up, power-on or reset or if a vehicle is not present, the detector assembly 20 may periodically function in state 64, as a result of the programming instructions in the memory, to activate the sensor 22 to determine a then-current ambient three-dimensional magnetic field around the sensor 22. The sensor 22 may then be returned to its normal deactivated state. The detector assembly 20 then functions, as a result of the programming instructions in the memory, to determine an adjusted baseline ambient three-dimensional magnetic field around the sensor 22 based on a difference in the then-current ambient three-dimensional magnetic field around the sensor 22 as compared to the baseline ambient three-dimensional magnetic field around the sensor 22. The detector assembly 20 then further functions, as a result of the programming instructions in the memory, to determine whether the difference exceeds the threshold that indicates the presence of the vehicle in the predefined location.

If no vehicle is detected then, the detector assembly 20 then functions, as a result of the programming instructions in the memory, to determine a then-current ambient three-dimensional magnetic field around the sensor 22 and to again determine an adjusted baseline ambient three-dimensional magnetic field around the sensor 22 based on a difference in the then-current ambient three-dimensional magnetic field around the sensor 22 as compared to the immediately prior adjusted baseline ambient three-dimensional magnetic field around the sensor 22. The detector assembly 20 then further functions, as a result of the programming instructions in the memory, to determine whether the difference exceeds the threshold that indicates the presence of the vehicle in the predefined location. Such steps are repeated periodically until the difference exceed the threshold to indicate the presence of a vehicle in the predefined location.

The adjusted baseline three-dimensional magnetic field around the sensor may not be determined as an absolute amount of the difference. Rather, in one preferred embodiment, the adjusted baseline is a result of an integration of the difference, such that, with a preferably small constant of integration the adjusted baseline is moved only a portion of the difference.

In state 64, the programming instructions in the memory may cause the detector assembly 20 to function to determine a temperature to be determined by the temperature sensor 24. The output from the temperature sensor 24 is used by the microprocessor in connection with programming instructions in the memory to function to adjust a selection from the group consisting of the baseline, then-current and adjusted baseline ambient three-dimensional magnetic field around the sensor and the threshold, based on a change from a prior temperature sensed. Preferably, each of the baseline, then-current and adjusted baseline ambient three-dimensional magnetic field around the sensor and the threshold are adjusted is response to a change in temperature as determined by the temperature sensor. Similar to the adjusted baseline ambient three-dimensional magnetic field around the sensor, the temperature adjustment to the baseline, then-current and adjusted baseline ambient three-dimensional magnetic field around the sensor and the threshold is a result of an integration of the measured and immediately measured temperature, such that, with a preferably small constant of integration the adjustments are moved only a portion of the difference.

If a vehicle is detected in the detector assembly's proximity, the state of the detector assembly 20 changes to the state shown at block 60. At this state, which may be considered a “car present” state, the timer function of the detector assembly 20 and/or server or any other device the may be performing a similar function may begin measuring the elapsed time from when the vehicle first appeared in the sensor's proximity.

If the vehicle departs before the allowed parking time elapses, the state of the detector assembly 20 will revert back to state 58. At state 60, the detector assembly 20 may then communicate with the server 42 regarding the absence of the vehicle and various data regarding that particular event (e.g., the amount of time that particular vehicle was parked at the parking stall)

Otherwise, the detector assembly 20 will track the elapsed time until the state shown at block 62 is reached. At this state, the vehicle is present in the proximity of the detector assembly 20, but the elapsed time has exceeded the allowed time. If the latter condition is true, the programming instructions stored in the memory cause the detector assembly 20 to function to activate the transceiver because the altered status requires notification of the remote device. The transceiver of the detector assembly 20 may then notify the remote device, server 42 or other suitable device of the altered status, (i.e., reporting on the vehicle's violation) so that the remote device, server 42 or other suitable device can dispatch an enforcement authority agent to issue a citation to the vehicle or initiate communication with the user to inquire if additional payment for the predefined location will be procured. In the event, the user elects to obtain additional time for the predefined location, the detector assembly reverts to states 60 and repeats the procedure. The state of the detector assembly 20 may revert back to state 58 after the vehicle has left the predetermined location or a citation has been issued.

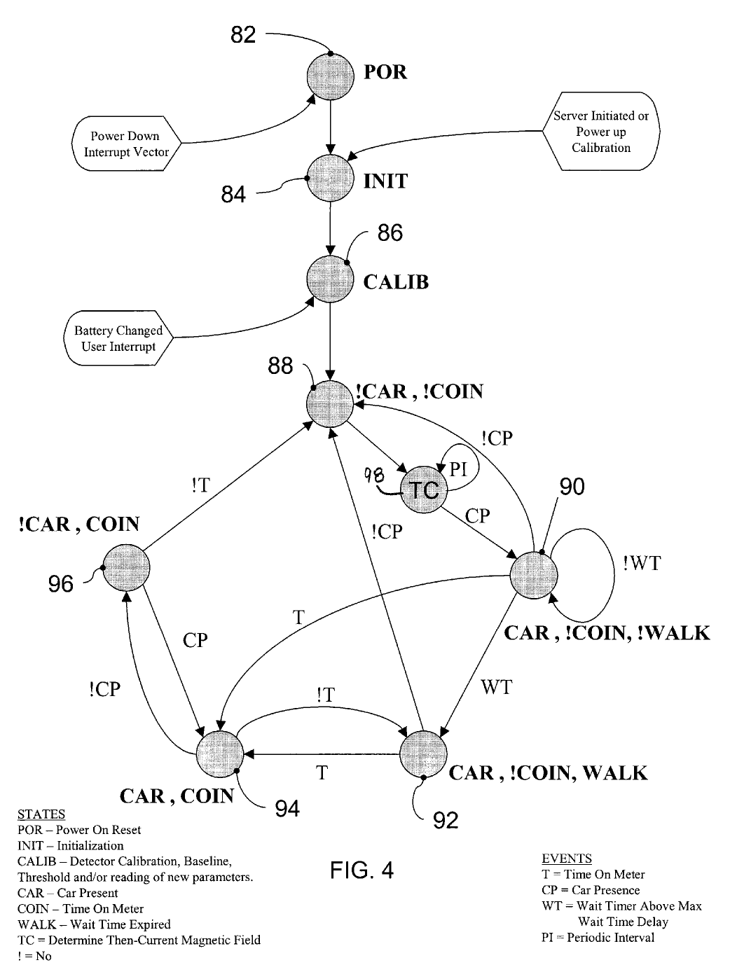

Referring to FIG. 4, a state diagram 80 of another embodiment of the disclosed vehicle parking management system 40 is shown, as above, only one detector assembly is shown for the sake of simplicity, all others in the same parking management system 40 operate in like manner. The state diagram of FIG. 4 represents a vehicle parking management system used in a parking facility where the vehicle owner is required to pay a certain fee prior to leaving the vehicle at the parking stall, such as depositing funds in a parking meter at the parking stall, depositing funds in the pay and display machine operatively coupled to the plurality of detector assemblies, or effect a transfer of funds from a payment source to the payment collection device, server, detector assembly or dynamic display.

The states of the detector assembly 20 at blocks 82-86 are similar to the states of the detector assembly 20 of FIG. 3 at states 52-56 and will not be described herein for the sake of brevity. State 88 represents a state of the detector assembly 20 where a vehicle is not in the proximity of the detector assembly 20 (as also indicated in FIG. 4 by the “no coin” terminology). If a vehicle is present and the time purchased for parking in the predefined location has expired, the detector assembly 20 can send a signal to the remote device, server 42 or other suitable device communicating such a condition so the server 42 can dispatch an officer to ticket the violating vehicle or contact the user to inquire if additional time will be purchased.

After state 88 the detector assembly will function in state 98 as set forth above with respect to state 64 and will not be repeated again here for the sake of brevity.

If the state of the detector assembly 20 at block 98 is that no vehicles are present, presence of a vehicle will place the detector assembly 20 in a state represented by block 90. At state 90, the detector assembly 20 has detected the presence of a vehicle, but the payment amount is still at zero and the time available for the predefined location is zero or expired. Because a certain amount of time may be necessary for the driver of the vehicle to deposit or pay the designated fee, perhaps with the payment collection device, or such as depositing funds in a parking meter at the parking stall, depositing funds in the pay and display machine operatively coupled to the plurality of detector assemblies disposed relatively adjacent the predefined location, or effect a transfer of funds from a payment source to the payment collection device, server, detector assembly or dynamic display, a delay shown as “walk time” may be allowed by the algorithms of each detector assembly 20. The walk time may be determined so as to give a driver of a vehicle more than sufficient time to deposit or pay the required fee. The walk time may be variable and set by the server 42 or other suitable remote device and stored in the detector assembly 20. If no funds are deposited or transferred after the walk time has elapsed, the state of the detector assembly will revert back to block 88. At this point, the detector assembly 20 may inform the server 42 or remote device so that the violating vehicle may be ticketed. However, if funds are deposited after the walk time has expired, the state of the detector assembly 20 will change from state 90 to state 94, where a vehicle is present and money has been allocated for such predefined location.

During the walk time period and when money has not yet been allocated for such predefined location, the state of the detector assembly 20 is shown by block 92, where a vehicle is present, the walk time has not expired, but money has not been allocated for such predefined location. If money is not allocated for such predefined location, the state of the detector assembly 20 reverts back to state 88 and the server 42 or remote device may be notified of the violation. If money is allocated for such predefined location, the state of the detector assembly 20 will change from state 92 to state 94. At state 94, the vehicle is present and time has been allocated for such predefined location. If the time expires, the state of the detector assembly 94 will revert back to state 92. At this point, if additional money is allocated for such predefined location, the state of the detector assembly 20 will return to state 94. If money is not deposited, however, the state of the detector assembly will revert to state 88 and a violation notification may be issued or further notification to the vehicle owner soliciting instruction regarding possible further allocation of funds for such predefined location.

While the detector assembly is at state 94, if the vehicle leaves the parking stall before the time allocated for such predefined location expires, the state of the detector assembly will change from state 94 to state 96. At this point, if another vehicle parks in the same predefined location while there is time remaining allocated thereto, the state of the detector assembly will revert back to state 94. Otherwise, the state of the detector assembly 20 will change to state 88, at which point, the detector assembly 20 informs the server 42 that a vehicle is not present but there is remaining time allocated thereto. The server 42 or remote device may send an instruction to the detector assembly 20 to auto-zero the time allocated for such predefined location when a vehicle is no longer sensed.

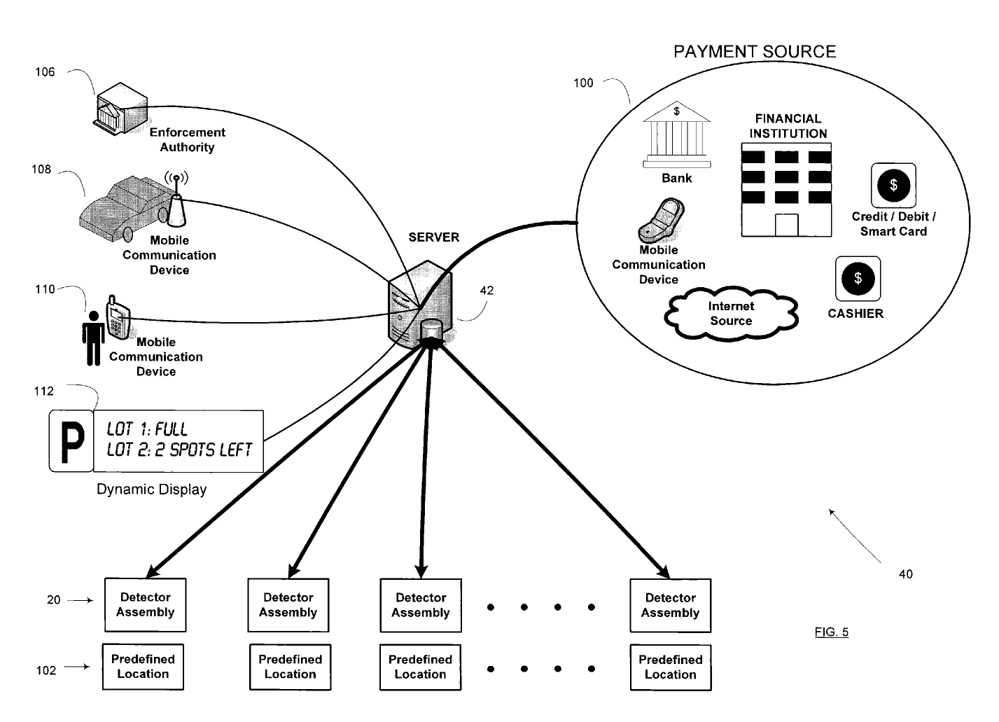

FIGS. 5-9 schematically illustrate various different embodiments of a vehicle parking management system constructed in accordance with the teachings of various embodiments of the present disclosure. Details of the operational states of the detector assemblies used in each of the embodiments illustrated in FIGS. 5-9 have been described in more detail with respect to FIG. 4. Accordingly, information will not be repeated here for the sake of brevity. Generally, a description of FIGS. 5-9 will be directed to the structural configuration, orientation and arrangements of the various components of a vehicle parking management system in each of the different embodiments. Operation of each of the vehicle parking management systems illustrated in FIGS. 5-9 should be readily apparent to one of skill in the art in view of the prior disclosure above with respect to FIG. 4. To the extent additional information with respect thereto is necessary, it will be made.

FIG. 5 illustrates a schematic diagram representing one vehicle parking management system constructed in accordance with the teachings of an embodiment of the present disclosure. The vehicle parking management system 40 comprises a plurality of detector assemblies 20, a server 42 operatively coupled to the plurality of detector assemblies and a payment source 100 operatively coupled to the server 42 in any manner as described above.

Each detector assembly 20 is associated with a predefined location 102 and is useful for determining the presence of a vehicle (not shown for clarity) disposed in the predefined location 102. An enforcement authority 106, mobile communication device 108, 110 and dynamic display 112 may be operatively coupled to the server 42 in any manner described above. Operation of the vehicle parking management system 40 illustrated in FIG. 5 is substantially as set forth with respect to FIG. 4.

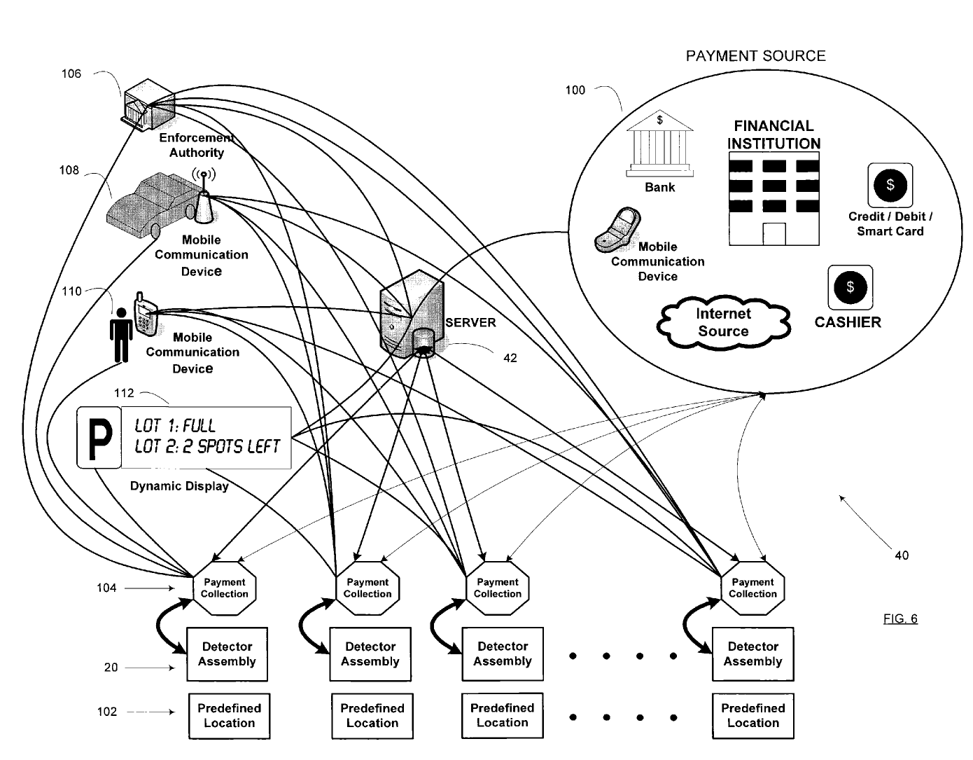

FIG. 6 illustrates a schematic diagram representing another vehicle parking management system 40 constructed in accordance with the teachings of another embodiment of the present disclosure. In this embodiment, the vehicle parking management system 40 comprises a plurality of detector assemblies 20 and a payment collection device 104 operatively coupled with each of the plurality of detector assembly 20 in any manner described above. This embodiment may often resemble or be configured such that the payment collection devices 104 are what is commonly referred to as parking meters. However, this embodiment is not restricted to parking meters, which has been offered by way of example and not of limitation. The vehicle parking management system 40 of FIG. 6 may further comprise a server 42 operatively coupled to each payment collection device 104 and an enforcement authority 106, mobile communication device 108, 110, dynamic display 112 and payment source 100 operatively coupled with the server 42 in any manner described above. Moreover, the embodiment for the vehicle parking management system 40 illustrated in FIG. 6 may further comprise a payment source 100 and an enforcement authority 106 operatively coupled to each payment collection device 104 in any manner described above. Such embodiment may still further comprise a mobile communication device 108, 110 and a dynamic display 112 operatively coupled to at least one payment collection device 104, namely such payment collection device associated with the predefined location in which the user's vehicle is disposed. One of skill in the art will note that in the various embodiments shown in FIG. 6, the payment collection devices 104 may function in some capacity similar to a conventional server to effect management of communications between various sources. However, a server 42 may provide more efficient management of such communication in practice.

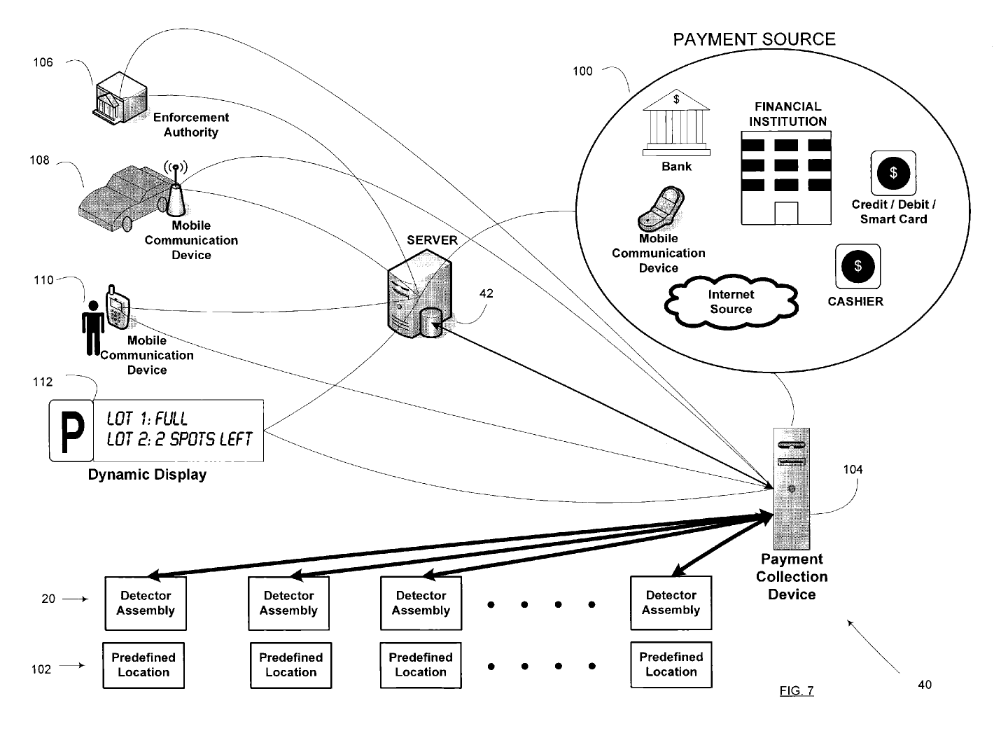

FIG. 7 illustrates a schematic diagram representing another vehicle parking management system 40 constructed in accordance with the teachings of another embodiment of the present disclosure. In this embodiment, a vehicle parking management system 40 comprises a plurality of detector assemblies 20 and a payment collection device 104 operatively coupled with the plurality of detector assemblies 20 in any manner described above. One of skill in the art will note that each of the detector assemblies 20 is operatively coupled to a common payment collection device 104 as opposed to the embodiment described in FIG. 6 wherein a payment collection device 104 was operatively coupled with each detector assembly 20. The embodiment shown in FIG. 7 may further comprise a server 42 operatively coupled to the payment collection device 104 and an enforcement authority 106, a mobile communication device 108, 110 and dynamic display 112 operatively coupled to the server 42 in any manner described above. Additionally, this embodiment may further comprise an enforcement authority 106, a mobile communication device 108, 110 and a dynamic display 112 operatively coupled to the payment collection device 104 in any manner described above. Finally, a payment source 100 may be operatively coupled to the payment collection device 104 and the server 42 in any manner described above. One of skill in the art will again note that the payment collection device 104 may be enabled with certain conventional server-type functions sufficient to enable the payment collection device 104 to operate the vehicle parking management system of this embodiment independent of a server 42. However, it may be more expedient in practice to employ a server 42 to facilitate network management and communication therein.

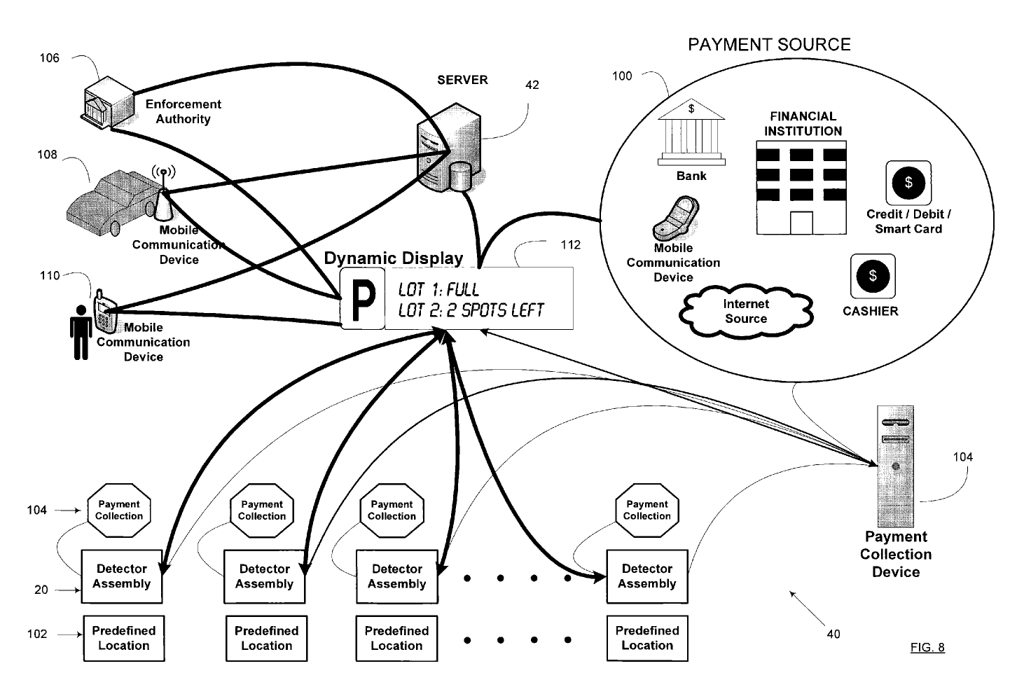

FIG. 8 is a schematic diagram representing another vehicle parking management system 40 constructed in accordance with the teachings of another embodiment of the present disclosure. In this embodiment, the vehicle parking management system 40 comprises the plurality of detector assemblies 20, a dynamic display 112 operatively coupled to the plurality of detector assemblies 20 and a payment source 100 operatively coupled to the dynamic display 112, both in any manner described above. This embodiment may further comprise a server 42 operatively coupled to the dynamic display 112 and an enforcement authority 106 or mobile communication device 108, 110 operatively coupled to the server 42, in any manner described above. This embodiment may also further comprise an enforcement authority 106 or mobile communication device 108, 110 operatively coupled to the dynamic display 112, in any manner described above. Moreover, this embodiment may further compromise a payment collection device 104 operatively coupled to each of the plurality of the detector assemblies 20 and the dynamic display 112 or a payment collection device 104 operatively coupled to the plurality of the detector assemblies 20 and the dynamic display 112, all in any manner described above. A payment source 100 is operatively coupled to each of the payment collection devices 104 in any manner described above. Some lines may have been left off the drawing for the sake of clarity.

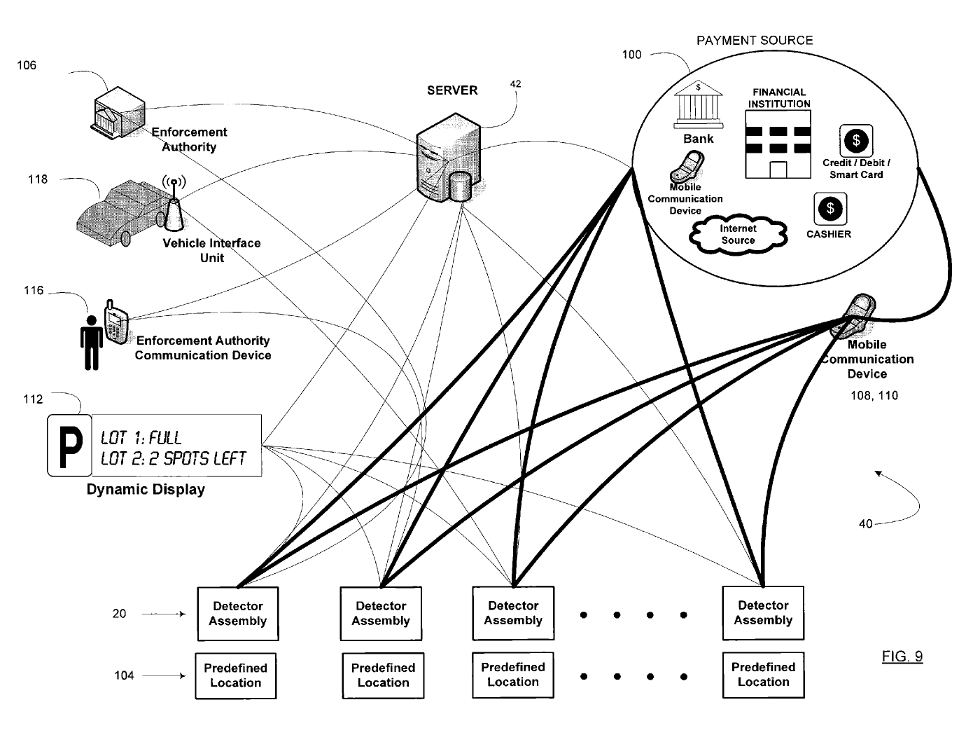

FIG. 9 is a schematic diagram representing another embodiment of the vehicle parking management system 40 constructed in accordance with the teachings of another embodiment of the present disclosure. In this embodiment, the vehicle parking management system 40 comprises a plurality of detector assemblies 20 , a mobile communication device 108, 110 operatively coupled to at least one of the plurality detector assemblies 20 and a payment source 100 operatively coupled to the mobile communication device 108, 110 and to at least one of the plurality of detector assemblies 20, all in any manner described above. This embodiment may also further comprise a server 42 operatively coupled to at least one of the plurality of detector assemblies 20, the mobile communication device 108, 110 and the payment source 100 in any manner described above. An enforcement authority 106, an enforcement authority communication device 116, a dynamic display 112 and a vehicle interface unit 118 may be operatively coupled to the server 42 and/or at least one of the plurality of detector assemblies 20 in any manner described above. Again, lines indicating operative coupling and/or communication have not all been included for the sake of clarity. One of skill in the art will recognize that the at least one of the plurality of detector assemblies 20 preferably refers to the predefined location in which a vehicle is disposed and payment or transfer of funds for such predefined location has not yet been allocated but is required as described in more detail above.

While the particular preferred embodiments have been shown and described, it will be obvious to those skilled in the art that changes and modifications may be made without departing from the teaching of the disclosure. For example, the detector assemblies may be mounted in any suitable or desirable location or orientation and provide the intended function. By way of example only and not any limitation, the detector assemblies may be disposed in walls, abutments, areas where parking of vehicles is not authorized, ceilings, etc. Moreover, the server, enforcement authority, mobile communication devices, payment source, payment collection device and dynamic display may take any suitable form provided that each is fitted with the necessary functionality as described herein. Further more, additional functionality associated with the operation of any embodiment of the vehicle parking management system may be modified or enhanced to provide further operational parameters as may be necessary for particular installations. The matter set forth in the foregoing description and accompanying drawings is offered by way of illustration only and not as limitation. The actual scope of the disclosure is intended to be defined in the following claims when viewed in their proper perspective based on the related art.

What is claimed is:

1. A detector assembly associated with a predefined location for determining the presence of a vehicle disposed in the predefined location, the detector assembly comprising:
(a) a passive, three-axis magnetic sensor;
(b) a transceiver operatively coupled to the sensor and adapted for bi-directional communication with a remote device; and
(c) a microprocessor operatively coupled to the sensor, the transceiver and a memory;
(d) wherein the memory stores programming instructions that, when used by the microprocessor, cause the detector assembly to function to:
(i) activate the sensor to determine a baseline ambient three-dimensional magnetic field around the sensor,
(ii) activate the sensor to determine a then-current ambient three-dimensional magnetic field around the sensor;
(iii) determine an adjusted baseline ambient three-dimensional magnetic field around the sensor based on a difference in the then-current ambient three-dimensional magnetic field around the sensor as compared to a selection from the group consisting of the baseline ambient three-dimensional magnetic field around the sensor and the adjusted baseline ambient three-dimensional magnetic field around the sensor;
(iv) determine whether the difference exceeds a threshold that indicates the presence of the vehicle in the predefined location; and
(v) repeat periodically steps (d)(ii), (d)(iii) and (d)(iv).

2. The detector assembly of claim 1, wherein the bidirectional communication is selected from the group consisting of a wireless connection and a wired connection.

3. The detector assembly of claim 1, further comprising a power source adapted to provide power to the microprocessor, the transceiver and the sensor.

4. The detector assembly of claim 3, wherein the sensor is deactivated unless performing steps (d)(i), (d)(ii) and (d)(v), such that the power provided by the power source is minimized.

5. The detector assembly of claim 1, wherein the programming instructions further cause the detector assembly to function to:
(i) establish a set of operational states;
(ii) establish a baseline status for each of the operational states;
(iii) determine whether the status of one of the operational states has been altered as a result of the detection of the vehicle; and
(iv) determine whether the altered status requires notification of the remote device.

6. The detector assembly of claim 5, wherein the programming instructions further cause the detector assembly to function to:
(i) activate the transceiver in the event the altered status requires notification of the remote device;
(ii) notify the remote device of the altered status; and
(iii) deactivate the transceiver.

7. The detector assembly of claim 1, further comprising an additional sensor.

8. The detector assembly of claim 7, wherein the additional sensor is a temperature sensor which generates an output to the microprocessor so that the microprocessor can use the output in connection with programming instructions in the memory to function to adjust a selection from the group consisting of the baseline, then-current and adjusted baseline ambient three-dimensional magnetic field around the sensor and the threshold.

9. The detector assembly of claim 7, wherein the additional sensor is an active sensor which is activated by the microprocessor in response to programming instructions in the memory when the vehicle is detected and functions to actively confirm presence of the vehicle.

10. The detector assembly of claim 1, wherein the programming instructions stored in the memory are selectively, dynamically alterable as a result of receipt of information by the transceiver from the remote device.

11. The detector assembly of claim 1, wherein the remote device is selected from the group consisting of a server, a payment source, an enforcement authority, a payment collection device, a mobile communication device, a vehicle interface unit and a dynamic display.

12. The detector assembly of claim 1, wherein the set of operational states are selected from the group consisting of sensor calibration, vehicle not present, vehicle present and vehicle present beyond permitted time.

13. A vehicle parking management system comprising:
(a) a plurality of detector assemblies;
(i) each detector assembly associated with a predefined location for determining the presence of a vehicle disposed in the predefined location and including a passive, three-axis magnetic sensor, a transceiver operatively coupled to the sensor and adapted for bi-directional communication; a microprocessor operatively coupled to the sensor, the transceiver and a memory; wherein the memory stores programming instructions that, when used by the microprocessor, cause the detector assembly to function to:
(1) activate the sensor to determine a baseline ambient three-dimensional magnetic field around the sensor,
(2) activate the sensor to determine a then-current ambient three-dimensional magnetic field around the sensor;
(3) determine an adjusted baseline ambient three-dimensional magnetic field around the sensor based on a difference in the then-current ambient three-dimensional magnetic field around the sensor as compared to a selection from the group consisting of the baseline ambient three-dimensional magnetic field around the sensor and the adjusted baseline ambient three-dimensional magnetic field around the sensor;
(4) determine whether the difference exceeds a threshold that indicates the presence of the vehicle in the predefined location; and
(5) repeat periodically steps (a)(i)(2), (a)(i)(3) and (a)(i)(4);
(ii) a server operatively coupled to the plurality of detector assemblies; and
(iii) a payment source operatively coupled to the server.

14. The vehicle parking management system of claim 13, further comprising an enforcement authority operatively coupled to the server.

15. The vehicle parking management system of claim 13, further comprising a mobile communication device operatively coupled to the server.

16. The vehicle parking management system of claim 13, wherein the mobile communication device is selected from the group consisting of a vehicle interface unit, a user communication device and an enforcement authority communication device.

17. The vehicle parking management system of claim 13, further comprising a dynamic display operatively coupled to the server.

18. A vehicle parking management system comprising:
(a) a plurality of detector assemblies;
(i) each detector assembly associated with a predefined location for determining the presence of a vehicle disposed in the predefined location and including a passive, three-axis magnetic sensor, a transceiver operatively coupled to the sensor and adapted for bi-directional communication; a microprocessor operatively coupled to the sensor, the transceiver and a memory; wherein the memory stores programming instructions that, when used by the microprocessor, cause the detector assembly to function to:
(1) activate the sensor to determine a baseline ambient three-dimensional magnetic field around the sensor,
(2) activate the sensor to determine a then-current ambient three-dimensional magnetic field around the sensor;
(3) determine an adjusted baseline ambient three-dimensional magnetic field around the sensor based on a difference in the then-current ambient three-dimensional magnetic field around the sensor as compared to a selection from the group consisting of the baseline ambient three-dimensional magnetic field around the sensor and the adjusted baseline ambient three-dimensional magnetic field around the sensor;
(4) determine whether the difference exceeds a threshold that indicates the presence of the vehicle in the predefined location; and
(5) repeat periodically steps (a)(i)(2), (a)(i)(3) and (a)(i)(4); and
(ii) a payment collection device operatively coupled with each of the plurality of detector assemblies.

19. The vehicle parking management system of claim 18, further comprising a server operatively coupled to each payment collection device.

20. The vehicle parking management system of claim 19, further comprising an enforcement authority operatively coupled to the server.

21. The vehicle parking management system of claim 19, further comprising a mobile communication device operatively coupled to the server.

22. The vehicle parking management system of claim 21, wherein the mobile communication device is selected from the group consisting of a vehicle interface unit, a user communication device and an enforcement authority communication device.

23. The vehicle parking management system of claim 19, further comprising a dynamic display operatively coupled to the server.

24. The vehicle parking management system of claim 18, further comprising an enforcement authority operatively coupled to each payment collection device.

25. The vehicle parking management system of claim 18, further comprising a mobile communication device operatively coupled to at least one payment collection device.

26. The vehicle parking management system of claim 25, wherein the mobile communication device is selected from the group consisting of a vehicle interface unit, a user communication device and an enforcement authority communication device.

27. The vehicle parking management system of claim 18, further comprising a dynamic display operatively coupled to at least one payment collection device.

28. The vehicle parking management system of claim 18, further comprising a payment source operatively coupled to each of the plurality of detector assemblies.

29. A vehicle parking management system comprising:
(a) a plurality of detector assemblies;
(i) each detector assembly associated with a predefined location for determining the presence of a vehicle disposed in the predefined location and including a passive, three-axis magnetic sensor, a transceiver operatively coupled to the sensor and adapted for bi-directional communication; a microprocessor operatively coupled to the sensor, the transceiver and a memory; wherein the memory stores programming instructions that, when used by the microprocessor, cause the detector assembly to function to:
(1) activate the sensor to determine a baseline ambient three-dimensional magnetic field around the sensor,
(2) activate the sensor to determine a then-current ambient three-dimensional magnetic field around the sensor;
(3) determine an adjusted baseline ambient three-dimensional magnetic field around the sensor based on a difference in the then-current ambient three-dimensional magnetic field around the sensor as compared to a selection from the group consisting of the baseline ambient three-dimensional magnetic field around the sensor and the adjusted baseline ambient three-dimensional magnetic field around the sensor;
(4) determine whether the difference exceeds a threshold that indicates the presence of the vehicle in the predefined location; and
(5) repeat periodically steps (a)(i)(2), (a)(i)(3) and (a)(i)(4); and
(ii) a payment collection device operatively coupled with the plurality of detector assemblies.

30. The vehicle parking management system of claim 29, further comprising a server operatively coupled to the payment collection device.

31. The vehicle parking management system of claim 30, further comprising an enforcement authority operatively coupled to the server.

32. The vehicle parking management system of claim 30, further comprising a mobile communication device operatively coupled to the server.

33. The vehicle parking management system of claim 32, wherein the mobile communication device is selected from the group consisting of a vehicle interface unit, a user communication device and an enforcement authority communication device.

34. The vehicle parking management system of claim 30, further comprising a dynamic display operatively coupled to the server.

35. The vehicle parking management system of claim 30, further comprising a payment source operatively coupled to the server.

36. The vehicle parking management system of claim 29, further comprising an enforcement authority operatively coupled to the payment collection device.

37. The vehicle parking management system of claim 29, further comprising a mobile communication device operatively coupled to the payment collection device.

38. The vehicle parking management system of claim 37, wherein the mobile communication device is selected from the group consisting of a vehicle interface unit, a user communication device and an enforcement authority communication device.

39. The vehicle parking management system of claim 29, further comprising a dynamic display operatively coupled to the payment collection device.

40. The vehicle parking management system of claim 29, further comprising a payment source operatively coupled to the payment collection device.

41. A vehicle parking management system comprising:
(a) a plurality of detector assemblies;
(i) each detector assembly associated with a predefined location for determining the presence of a vehicle disposed in the predefined location and including a passive, three-axis magnetic sensor, a transceiver operatively coupled to the sensor and adapted for bi-directional communication; a microprocessor operatively coupled to the sensor, the transceiver and a memory; wherein the memory stores programming instructions that, when used by the microprocessor, cause the detector assembly to function to:
(1) activate the sensor to determine a baseline ambient three-dimensional magnetic field around the sensor,
(2) activate the sensor to determine a then-current ambient three-dimensional magnetic field around the sensor;
(3) determine an adjusted baseline ambient three-dimensional magnetic field around the sensor based on a difference in the then-current ambient three-dimensional magnetic field around the sensor as compared to a selection from the group consisting of the baseline ambient three-dimensional magnetic field around the sensor and the adjusted baseline ambient three-dimensional magnetic field around the sensor;
(4) determine whether the difference exceeds a threshold that indicates the presence of the vehicle in the predefined location; and
(5) repeat periodically steps (a)(i)(2), (a)(i)(3) and (a)(i)(4);
(ii) a dynamic display operatively coupled to the plurality of detector assemblies; and
(iii) a payment source operatively coupled to the dynamic display.

42. The vehicle parking management system of claim 41, further comprising a server operatively coupled to the dynamic display.

43. The vehicle parking management system of claim 42, further comprising an enforcement authority operatively coupled to the server.

44. The vehicle parking management system of claim 42, further comprising a mobile communication device operatively coupled to the server.

45. The vehicle parking management system of claim 44, wherein the mobile communication device is selected from the group consisting of a vehicle interface unit, a user communication device and an enforcement authority communication device.

46. The vehicle parking management system of claim 41, further comprising an enforcement authority operatively coupled to the dynamic display.

47. The vehicle parking management system of claim 41, further comprising a mobile communication device operatively coupled to the dynamic display.

48. The vehicle parking management system of claim 47, wherein the mobile communication device is selected from the group consisting of a vehicle interface unit, a user communication device and an enforcement authority communication device.

49. The vehicle parking management system of claim 41, further comprising a payment collection device operatively coupled to each of the plurality of detector assemblies and the dynamic display.

50. The vehicle parking management system of claim 49, further comprising a payment source operatively coupled to each of the payment collection devices.

51. The vehicle parking management system of claim 41, further comprising a payment collection device operatively coupled to the plurality of detector assemblies and the dynamic display.

52. The vehicle parking management system of claim 51, further comprising a payment source operatively coupled to the payment collection device.

53. A vehicle parking management system comprising:
(a) a plurality of detector assemblies;
(i) each detector assembly associated with a predefined location for determining the presence of a vehicle disposed in the predefined location and including a passive, three-axis magnetic sensor, a transceiver operatively coupled to the sensor and adapted for bi-directional communication; a microprocessor operatively coupled to the sensor, the transceiver and a memory; wherein the memory stores programming instructions that, when used by the microprocessor, cause the detector assembly to function to:
(1) activate the sensor to determine a baseline ambient three-dimensional magnetic field around the sensor,
(2) activate the sensor to determine a then-current ambient three-dimensional magnetic field around the sensor;
(3) determine an adjusted baseline ambient three-dimensional magnetic field around the sensor based on a difference in the then-current ambient three-dimensional magnetic field around the sensor as compared to a selection from the group consisting of the baseline ambient three-dimensional magnetic field around the sensor and the adjusted baseline ambient three-dimensional magnetic field around the sensor;
(4) determine whether the difference exceeds a threshold that indicates the presence of the vehicle in the predefined location; and
(5) repeat periodically steps (a)(i)(2), (a)(i)(3) and (a)(i)(4);
(ii) a mobile communication device operatively coupled to at least one of the plurality of detector assemblies; and
(iii) a payment source operatively coupled to the mobile communication device and the at least one of the plurality of detector assemblies.

54. The vehicle parking management system of claim 53, wherein the mobile communication device is selected from the group consisting of a vehicle interface unit and a user communication device.

55. The vehicle parking management system of claim 53, further comprising a server operatively coupled to the at least one of the plurality of detector assemblies, the mobile communication device and the payment source.

56. The vehicle parking management system of claim 55, further comprising an enforcement authority operatively coupled to the server.

57. The vehicle parking management system of claim 55, further comprising an enforcement authority communication device operatively coupled to the server.

58. The vehicle parking management system of claim 55, further comprising a dynamic display operatively coupled to the server.

59. The vehicle parking management system of claim 55, further comprising a vehicle interface unit operatively coupled to the server.

60. The vehicle parking management system of claim 53, further comprising an enforcement authority operatively coupled to the at least one of the plurality of detector assemblies.

61. The vehicle parking management system of claim 53, further comprising an enforcement authority communication device operatively coupled to the at least one of the plurality of detector assemblies.

62. The vehicle parking management system of claim 53, further comprising a dynamic display operatively coupled to the plurality of detector assemblies.
